(19) United States
(12) Patent Application Publication
(10) Pub. No.: US 2026/0216839 A1
(43) Pub. Date: Jul. 30, 2026

(54) INFORMATION PROCESSING DEVICE, INFORMATION PROCESSING METHOD, AND RECORDING MEDIUM

(71) Applicant: Panasonic Intellectual Property Management Co., Ltd., Osaka (JP)

(72) Inventors: Satoshi SAWANO, Osaka (JP); Masato MATSUMOTO, Osaka (JP); Yusuke KINOSHITA, Kyoto (JP); Yuji KUDOH, Osaka (JP)

(21) Appl. No.: 19/147,580

(22) PCT Filed: Dec. 25, 2023
(86) PCT No.: PCT/JP2023/046433

§ 371 Date: Jul. 11, 2025

(30) Foreign Application Priority Data
Feb. 6, 2023 (JP) 2023-015974

(51) Int. Cl. B23Q 15/12; G01H 1/00

(52) U.S. Cl. CPC B23Q 15/12; G01H 1/003; B23Q 2717/00

(57) ABSTRACT

A specific vibration produced by machining equipment is detected early. An information processing device includes: an obtainer that obtains vibration data indicating vibration produced during machining performed by the machining equipment; an analyzer that analyzes the vibration data obtained by the obtainer to identify one or more specific frequencies that are one or more frequencies of specific vibrations included in the vibration indicated in the vibration data; a filter that extracts a vibration component that includes the one or more specific frequencies and is included in the vibration indicated in the vibration data obtained by the obtainer, and calculates an amplitude of the vibration component extracted; and a display that displays the amplitude calculated by the filter.

### TECHNICAL FIELD

The present disclosure relates to an information processing device, an information processing method, and a program.

### BACKGROUND ART

In machining, such as cutting, grinding, or polishing, performed, for example, by machining equipment on a workpiece, the machining equipment may produce chatter vibration. Since such chatter vibration may cause deterioration in the quality of machining (e.g., the generation of stripes on a machined surface), control to detect the chatter vibration early and suppress the chatter vibration is required.

There is a technique known in the art for reducing chatter vibration produced during machining (see Patent Literature (PTL) 1).

### CITATION LIST

### Patent Literature

### [PTL 1]

Japanese Unexamined Patent Application Publication No. 2021-20260

### Non Patent Literature

### [NPL 1]

“Kalman Filter-Wikipedia”, [retrieved on Feb. 1, 2023], Internet <URL: https://ja.wikipedia.org/wiki/% E3%82% AB % E3% 83% AB % E3% 83% 9E % E3%83% B3% E3% 83% 95% E3% 82% A3% E3% 83% AB % E3% 82% BF % E3%83% BC>

### [NPL 2]

Kiyoshi Ohishi, Kouhei Ohnishi, and Kunio Miyachi, “Torque-speed regulation of dc motor based on load torque estimation method,” JIEE/1983 International Power Electronics Conference, IPEC-TOKYO, Tokyo, Japan

### SUMMARY OF INVENTION

However, a problem with the technique described in PTL 1 is that a certain amount of time may be required to identify a frequency of chatter vibration (also referred to as a chatter frequency). The chatter vibration continues until control to suppress the chatter vibration is performed. Therefore, deterioration in the quality of machining due to the chatter vibration becomes significant when the identifying of the frequency of the chatter vibration takes some time.

In view of this, the present disclosure provides an information processing device, etc., capable of early detection of a particular vibration (also referred to as a specific vibration) produced by machining equipment.

An information processing device according to one aspect of the present disclosure is an information processing device including: an obtainer that obtains vibration data indicating vibration produced during machining performed by machining equipment; an analyzer that analyzes the vibration data obtained by the obtainer to identify one or more specific frequencies that are one or more frequencies of specific vibrations included in the vibration indicated in the vibration data; a filter that extracts a vibration component that includes the one or more specific frequencies and is included in the vibration indicated in the vibration data obtained by the obtainer, and calculates an amplitude of the vibration component extracted; and an outputter that outputs the amplitude calculated by the filter.

These general or specific aspects may be implemented using a system, a method, an integrated circuit, a computer program, or a computer-readable recording medium such as a CD-ROM, or any combination of systems, methods, integrated circuits, computer programs, and recording media.

The information processing device of the present disclosure is capable of the early detection of the specific vibration produced by the machining equipment.

### BRIEF DESCRIPTION OF DRAWINGS

FIG. 1 is a schematic diagram illustrating configurations of an information processing device and a system in an embodiment.

FIG. 2 is a first flow diagram showing processing by the information processing device in the embodiment.

FIG. 3 is an explanatory diagram showing time ranges in processing by a filter in the embodiment.

FIG. 4 is an explanatory diagram showing mapping between the time ranges and frequencies in the processing by the filter in the embodiment.

FIG. 5 is a schematic diagram illustrating an example of the configuration of the information processing device in the embodiment.

FIG. 6 is an explanatory diagram showing mapping between filters and frequencies in the processing by the filters in the embodiment.

FIG. 7 is an explanatory diagram showing an example of data for output, which is generated by the filter in the embodiment.

FIG. 8 is an explanatory diagram showing a first example of an image outputted by the information processing device in the embodiment.

FIG. 9 is an explanatory diagram showing a second example of the image outputted by the information processing device in the embodiment.

FIG. 10 is an explanatory diagram showing a third example of the image outputted by the information processing device in the embodiment.

FIG. 11 is an explanatory diagram showing a fourth example of the image outputted by the information processing device in the embodiment.

FIG. 12 is a schematic diagram illustrating configurations of an information processing device and a system in a variation of the embodiment.

### DESCRIPTION OF EMBODIMENTS

### (Underlying Knowledge Forming Basis of the Present Disclosure)

The present inventor has found that the following problem arises in connection with the technique related to machining equipment, which has been described in the section of “Background Art”.

In the technique described in PTL 1, a chatter frequency is identified by performing a Fast Fourier Transform (FFT) analysis on vibration produced by machining equipment.

Generally, in the FFT analysis, an amplitude of a vibration component for each of all frequencies to be detected is calculated. Moreover, a predetermined amount of time is required to obtain vibration data to be subjected to the FFT analysis. Therefore, a problem with the detection of chatter vibration using the FFT analysis is that a certain amount of time may be required.

In the meantime, the calculation of an amplitude of a vibration component for each of all frequencies to be detected is not necessarily required to detect chatter vibration produced by machining equipment. In other words, the detection of the chatter vibration produced by the machining equipment requires calculating an amplitude of a vibration component of a chatter vibration being produced among vibrations produced by the machining equipment, but does not necessarily require calculating amplitudes of the other vibration components.

In view of this, the invention according to the present disclosure provides an information processing device, etc., capable of early detection of a frequency of a specific vibration produced by machining equipment.

An invention that can be obtained from the disclosure of the present specification will be exemplified, and effects, etc. that can be obtained from the invention will be described below.

(1) An information processing device including: an obtainer that obtains vibration data indicating vibration produced during machining performed by machining equipment; an analyzer that analyzes the vibration data obtained by the obtainer to identify one or more specific frequencies that are one or more frequencies of specific vibrations included in the vibration indicated in the vibration data; a filter that extracts a vibration component that includes the one or more specific frequencies and is included in the vibration indicated in the vibration data obtained by the obtainer, and calculates an amplitude of the vibration component extracted; and an outputter that outputs the amplitude calculated by the filter.

According to the aspect described above, the information processing device identifies a specific frequency included in vibration produced during machining performed by the machining equipment, and then outputs an amplitude of a vibration with the specific frequency identified. At this time, there is no need to calculate amplitudes of vibrations with frequencies other than the specific frequency. Therefore, the calculation processing can be significantly reduced as compared to a case where the amplitudes of the vibrations with the frequencies other than the specific frequency are also calculated. This allows the information processing device to reduce the time required for the calculation processing and to reduce power consumption required for the calculation processing. Thus, the information processing device is capable of the early detection of the specific vibration produced by the machining equipment.

(2) The information processing device according to (1), in which the analyzer identifies one specific frequency as the one or more specific frequencies, and the filter extracts a vibration component that includes the one specific frequency and is included in the vibration, and calculates an amplitude of the vibration component extracted.

According to the aspect described above, the information processing device identifies the one specific frequency included in the vibration produced during the machining performed by the machining equipment, and then outputs the amplitude of the vibration with the one specific frequency identified. Thus, the information processing device can achieve more easily the early detection of the one specific vibration produced by the machining equipment.

(3) The information processing device according to (1), in which the analyzer identifies N specific frequencies as the one or more specific frequencies, N being an integer that is greater than or equal to two, and the filter: maps each of the N specific frequencies to a time range among N time ranges; and for each of the N time ranges, extracts a vibration component including the specific frequency, among the N specific frequencies, that is mapped to the time range, and calculates an amplitude of the vibration component extracted.

According to the aspect described above, the information processing device identifies a plurality of specific frequencies included in vibration produced during machining performed by the machining equipment, and then outputs amplitudes of vibrations with the plurality of specific frequencies identified. The calculation of the amplitudes of the vibrations with the plurality of specific frequencies is performed by the filter in a time-division manner. Therefore, even when there are a plurality of specific frequencies to be targeted, there is no need to increase the number of filters. In other words, there is an advantage of being able to calculate, with the same device configuration, the amplitudes of the vibrations with the plurality of specific frequencies. Thus, the information processing device can achieve more easily the early detection of the plurality of specific vibrations produced by the machining equipment.

(4) The information processing device according to any one of (1) to (3), in which when calculating the amplitude of the vibration component, the filter calculates the amplitude of the vibration component in association with a temporal position of the vibration component included in the vibration data, and when outputting the amplitude, the outputter outputs the amplitude in association with the temporal position, the amplitude being calculated by the filter in association with the temporal position.

According to the aspect described above, the information processing device outputs an amplitude of a specific vibration produced by the machining equipment with the amplitude being associated with the temporal position of the amplitude. Therefore, the information processing device can perform control to enable other processing using the temporal variations in the amplitude of the specific vibration to be performed appropriately. Moreover, when the output performed by the information processing device is display on a display screen, a user who views the display can easily know the temporal variations in the amplitude of the specific vibration. Thus, the information processing device is capable of the early detection of the specific vibration produced by the machining equipment, as well as the control to enable other processing related to the detected specific vibration to be performed appropriately.

(5) The information processing device according to (1), in which the analyzer identifies N frequencies as the one or more specific frequencies, N being an integer that is greater than or equal to two, the filter: includes N filters; and maps each of the N specific frequencies to a filter among the N filters, and each of the N filters extracts a vibration component including the specific frequency, among the N specific frequencies, that is mapped to the filter, and calculates an amplitude of the vibration component extracted.

According to the aspect described above, the information processing device identifies a plurality of specific frequencies included in vibration produced during machining performed by the machining equipment, and then outputs amplitudes of vibrations with the plurality of specific frequencies identified. The calculation of the amplitudes of the vibrations with the plurality of specific frequencies is performed in parallel by the plurality of filters. Therefore, there is an advantage of being able to calculate the amplitudes of the vibrations with the plurality of specific frequencies continuously in time. Thus, the information processing device is capable of the early detection of the plurality of specific vibrations produced by the machining equipment.

(6) The information processing device according to (5), in which when calculating the amplitude of the vibration component, each of the N filters calculates the amplitude of the vibration component in association with a temporal position of the vibration component included in the vibration data, and when outputting the amplitude, the outputter outputs the amplitude in association with the temporal position, the amplitude being calculated by each of the N filters in association with the temporal position.

According to the aspect described above, the information processing device outputs amplitudes of a plurality of specific vibrations produced by the machining equipment with the amplitudes being associated with the temporal positions of the amplitudes. Therefore, the information processing device can perform control to enable other processing using the temporal variations in the amplitudes of the plurality of specific vibrations to be performed appropriately. Moreover, when the output performed by the information processing device is display on a display screen, a user who views the display can easily know the temporal variations in the amplitudes of the plurality of specific vibrations. Thus, the information processing device is capable of the early detection of the plurality of specific vibrations produced by the machining equipment, as well as the control to enable other processing related to the plurality of specific vibrations detected to be performed appropriately.

(7) The information processing device according to (1), in which the obtainer obtains the vibration data from a vibration sensor that detects vibration produced during machining performed by the machining equipment.

According to the aspect described above, the information processing device outputs an amplitude of a vibration with a specific frequency on the basis of the vibration data obtained from the vibration sensor. Thus, the information processing device is capable of the early detection of the specific vibration produced by the machining equipment by using the vibration sensor.

(8) The information processing device according to (1), in which the obtainer further includes an estimator that obtains a control value outputted by the machining equipment and uses the control value obtained to estimate machining force exerted on a workpiece by the machining equipment, and the obtainer obtains, as the vibration data, estimation data of the machining force estimated by the estimator.

According to the aspect described above, the information processing device outputs an amplitude of a vibration with a specific frequency on the basis of the control value outputted by the machining equipment. Thus, the information processing device is capable of the early detection of the specific vibration produced by the machining equipment by using the control value outputted by the machining equipment.

(9) The information processing device according to (1), in which the analyzer: includes a Kalman filter; and identifies the one or more specific frequencies by estimation using the Kalman filter, and the filter: includes a bandpass filter; and extracts a vibration component that includes the one or more specific frequencies using the bandpass filter that uses each of the one or more specific frequencies as a pass frequency.

According to the aspect described above, the information processing device identifies a specific frequency using the Kalman filter and extracts a vibration component with the specific frequency using the bandpass filter. Thus, the information processing device can achieve more easily the early detection of the specific vibration produced by the machining equipment by using the Kalman filter and the bandpass filter.

(10) An information processing method including: obtaining vibration data indicating vibration produced during machining performed by machining equipment; analyzing the vibration data obtained to identify one or more specific frequencies that are one or more frequencies of specific vibrations included in the vibration indicated in the vibration data; extracting a vibration component that includes the one or more specific frequencies and is included in the vibration indicated in the vibration data obtained, and calculating an amplitude of the vibration component extracted; and outputting the amplitude calculated.

According to the aspect described above, the same effects as those of the information processing device described above are produced.

(11) A program for causing a computer to execute the information processing method according to (10).

According to the aspect described above, the same effects as those of the information processing device described above are produced.

These general or specific aspects may be implemented using a system, a method, an integrated circuit, a computer program, or a computer-readable recording medium such as a CD-ROM, or any combination of systems, methods, integrated circuits, computer programs, or recording media.

An embodiment will be specifically described below with reference to the drawings.

Each embodiment described below shows a general or specific example. The numerical values, shapes, materials, elements, the arrangement and connection of the elements, steps, the processing order of the steps, etc., shown in the following embodiment are mere examples, and therefore do not limit the scope of the present invention. Therefore, among the elements in the following embodiment, those not recited in any one of the independent claims indicating the highest-level concept are described as optional elements.

### EMBODIMENT

In the present embodiment, an information processing device, etc., capable of early detection of a specific vibration produced by machining equipment will be described.

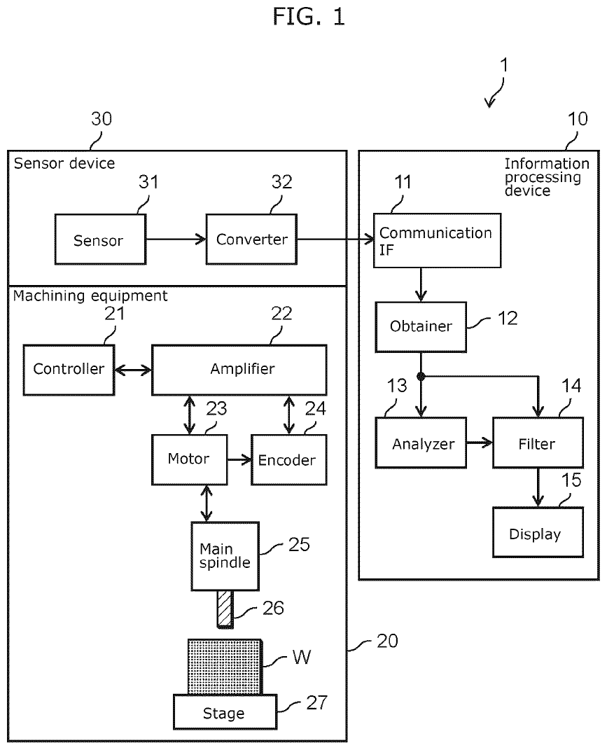

FIG. 1 is a schematic diagram illustrating configurations of information processing device 10 in the present embodiment and system 1 including information processing device 10.

System 1 includes information processing device 10, machining equipment 20, and sensor device 30. Information processing device 10 is connected to sensor device 30. Information processing device 10 may be a device that diagnoses machining equipment 20 or machining performed by machining equipment 20 by analyzing, for example, vibration produced during machining performed by machining equipment 20 (which may also be referred to generally as a diagnostic device or an analyzing device). Information processing device 10 may also be included in the above-described device as a function of the above-described device.

Machining equipment 20 and sensor device 30 will be described first.

Machining equipment 20 is a device that performs machining on workpiece W. Examples of machining include cutting, grinding, or polishing.

As shown in FIG. 1, machining equipment 20 includes controller 21, amplifier 22, motor 23, encoder 24, main spindle 25, and tool 26. Note that workpiece W is not included in elements of machining equipment 20.

Controller 21 controls the elements included in machining equipment 20. Controller 21 includes a processor (e.g., a Central Processing Unit (CPU)) (not shown). The processor executes a predetermined program using a memory (not shown) to perform the above-described control.

Controller 21 controls the elements included in machining equipment 20 to machine workpiece W. An object to be controlled is main spindle 25, for example, and description will be made taking this case as an example. However, the above-described elements may also include stage 27, etc.

Controller 21 controls the position of main spindle 25 so that main spindle 25 is properly positioned. Controller 21 also controls the rotational speed of main spindle 25 and tool 26 so that tool 26 machines workpiece W. Controller 21 provides, to amplifier 22, a signal to control the position of main spindle 25 after the control (also referred to as a controlled position), the rotational speed of main spindle 25 after the control (a controlled rotational speed), or the torque of main spindle 25 after the control (also referred to as controlled torque).

Amplifier 22 is an amplifier that drives motor 23 by supplying electric power to motor 23. Amplifier 22 may include a servo amplifier that drives a servomotor, which is motor 23 that controls the position of main spindle 25, or a spindle amplifier that drives a spindle motor, which is motor 23 that controls the rotation of main spindle 25.

When amplifier 22 obtains, from controller 21, the signal to control the controlled position, controlled rotational speed, or controlled torque of main spindle 25, amplifier 22 calculates a driving amount of motor 23 to change the position, rotational speed, or torque of main spindle 25 according to the control signal, and supplies, to motor 23, electric power to drive motor 23 with the calculated driving amount. Amplifier 22 can also receive, from encoder 24 as feedback, information indicating the position or rotational speed of motor 23, and can further adjust the position or rotational speed of main spindle 25 by using the feedback. Since motor 23 and main spindle 25 are directly connected to each other, it can be said that the information indicating the position or rotational speed of motor 23 is information indicating the position or rotational speed of main spindle 25. Note that machining equipment 20 is provided with as many amplifiers 22 as necessary to drive one or more motors 23.

Motor 23 is a motor that controls the position or rotational speed of main spindle 25. Motor 23 may include a servomotor that controls the position of main spindle 25 or a spindle motor that controls the rotation of main spindle 25. Motor 23 controls the position or rotational speed of main spindle 25 by being driven by the electric power supplied by amplifier 22.

Note that the number of motors 23 is not limited to one, but may be greater than or equal to one. When the position or rotational speed of main spindle 25 is controlled, for example, one or more motors for controlling the position of main spindle 25 and one or more motors for controlling the rotational speed of main spindle 25 may be provided. When the number of motors 23 is greater than or equal to one, as many amplifiers 22 as necessary to drive such one or more motors 23 are provided. When stage 27 is an object to be controlled by controller 21, one or more motors for controlling the position of stage 27 are included.

Encoder 24 is a sensor that obtains information indicating the position or rotational speed of main spindle 25. Encoder 24 provides, to amplifier 22 as feedback, the obtained information indicating the position or rotational speed of main spindle 25. Encoder 24 may be a linear encoder or a rotary encoder.

Main spindle 25 rotatably supports tool 26. Specifically, main spindle 25 has a jig, such as a chuck, for holding tool 26, and holds tool 26 using the jig. Main spindle 25 also causes tool 26 to rotate around a rotary axis (i.e., rotate on its own axis).

Tool 26 is a tool to machine workpiece W. Tool 26 is supported by main spindle 25 to be able to rotate around the rotary axis (i.e., rotate on its own axis). Workpiece W is machined as a result of rotating tool 26 contacting workpiece W.

Stage 27 is a stage on which workpiece W is to be placed. Stage 27 may be stationary or movable. When stage 27 is movable, a motor (not shown) for moving stage 27 is provided, and a servo amplifier (not shown) for supplying electric power to the motor is also provided.

When machining equipment 20 machines workpiece W, vibration is produced in motor 23, main spindle 25, tool 26, or stage 27, for example. The produced vibration is transmitted to sensor device 30 and becomes an object to be detected by sensor device 30.

Sensor device 30 is a device provided to machining equipment 20 for detecting a physical phenomenon that occurs during machining performed by machining equipment 20 and outputting a sensor value. More specifically, sensor device 30 detects vibration that occurs during machining performed by machining equipment 20 and outputs a sensor value indicating the vibration. For example, sensor device 30 is provided in contact with machining equipment 20 and detects vibration transmitted from machining equipment 20. Note that sensor device 30 may be provided without being in contact with machining equipment 20 (in other words, with a space from machining equipment 20). In that case, sensor device 30 detects vibration (e.g., a sound wave) produced by machining equipment 20 and transmitted through the space.

Sensor device 30 includes sensor 31 and converter 32.

Sensor 31 is a sensor (also referred to generally as a sensor element) that detects a physical phenomenon that is an object to be detected. Sensor 31 is, for example, an acceleration sensor, and description will be made taking this case as an example. However, sensor 31 may be a voltage sensor, a current sensor, or a temperature sensor, for example. Sensor 31 provides, to converter 32, an analog sensor value indicating the detected physical phenomenon (also referred to as an analog sensor value).

Converter 32 converts the analog sensor value provided by sensor 31 into a digital sensor value (also referred to simply as a sensor value), and transmits the digital sensor value to information processing device 10. Converter 32 obtains the analog sensor value provided by sensor 31, repeatedly converts such an analog sensor value into a sensor value, and transmits the sensor value to information processing device 10. Converter 32 can repeatedly convert an analog sensor value into a sensor value at a predetermined interval (also referred to as a sampling period). The converting of the analog sensor value into the sensor value may include analog-to-digital conversion processing, filter processing, and buffer processing, for example. The transmitting of the sensor value to information processing device 10 by converter 32 corresponds to outputting of the sensor value.

Specifically, sensor 31, which is an acceleration sensor, detects vibration that occurs during machining performed by machining equipment 20, and provides an analog sensor value indicating an acceleration to converter 32. Converter 32 converts the analog sensor value indicating the acceleration, which has been provided by sensor 31, into a sensor value indicating the acceleration. The sensor value indicating the acceleration, which has been obtained as a result of the conversion by converter 32, corresponds to vibration data indicating the vibration produced during the machining.

Information processing device 10 will be described next.

As shown in FIG. 1, information processing device 10 includes communication interface (IF) 11, obtainer 12, analyzer 13, filter 14, and display 15. Part or all of the functions of obtainer 12, analyzer 13, filter 14, and display 15 are implemented as a result of a processor (e.g., a CPU) (not shown) included in information processing device 10 executing a predetermined program using a memory (not shown). Information processing device 10 is an information processing device capable of early detection of a specific vibration produced by machining equipment 20.

Communication IF 11 is a communication interface connected to sensor device 30 to enable communication with sensor device 30. The communication standard for communication IF 11 is a wired Local Area Network (LAN) such as IEEE 802.3, for example. However, the communication standard is not limited to this, but may be a wireless LAN (IEEE 802.11 series, etc.).

Obtainer 12 obtains, from sensor device 30 via communication IF 11, the vibration data indicating the vibration produced during the machining performed by machining equipment 20. Obtainer 12 provides the obtained vibration data to analyzer 13.

Analyzer 13 identifies a frequency of chatter vibration produced during machining performed by machining equipment 20. Note that the chatter vibration produced during machining performed by machining equipment 20 is an example of a specific vibration, which is a particular vibration component included in the vibration produced during the machining performed by machining equipment 20, and the frequency of the chatter vibration identified by analyzer 13 is an example of a specific frequency identified by analyzer 13.

Analyzer 13 analyzes the vibration data obtained by obtainer 12 to identify one or more chatter frequencies that are one or more frequencies of chatter vibrations included in the vibration indicated in the vibration data.

Analyzer 13 is implemented, for example, using a Kalman filter, which is a well-known technique (see NPL 1). In this case, analyzer 13 includes a Kalman filter and identifies one or more chatter frequencies by estimation using the Kalman filter.

Analyzer 13 can, for example, use the Kalman filter to estimate chatter frequency x[i+1] at step i+1 (provided that i>0) as follows.

x[i+1]=A·x[i]+B·u[i]+v[i] (state equation)

y[i]=C·x[i]+B·u[i]+w[i] (output equation)

where v[k] is system noise and w[k] is observation noise. v[k] and w[k] are mutually independent white Gaussian noise. u[i] denotes a system input and here, u[i] is set to 0. y[i] denotes an output, which is the vibration data obtained by obtainer 12. A, B, and C denote coefficient matrices. By using this, analyzer 13 can derive, from y[i], an estimated value of chatter frequency x[i].

Note that analyzer 13 is not limited to the Kalman filter, but may also be implemented by other techniques (e.g., a time-frequency analysis technique, which is a well-known technique).

Filter 14 extracts a vibration component that includes one or more chatter frequencies and is included in the vibration indicated in the vibration data obtained by analyzer 13, and calculates an amplitude of the extracted vibration component. The above-described one or more chatter vibrations are one or more chatter vibrations identified by analyzer 13.

Filter 14 is implemented, for example, using a bandpass filter. In this case, filter 14 extracts a vibration component that includes one or more chatter frequencies using a bandpass filter that uses each of the one or more chatter frequencies as a pass frequency.

Display 15 has a display screen and displays information on the display screen as an image. Display 15 outputs information indicating the amplitude calculated by filter 14 (also referred to simply as an amplitude) by displaying the information as an image.

In displaying the amplitude, display 15 may display the amplitude, which has been calculated by filter 14 in association with its temporal position, with the amplitude being associated with the temporal position. In this case, it is assumed that when calculating an amplitude of a vibration component, filter 14 calculates the amplitude of the vibration component in association with the temporal position of the vibration component included in the vibration data.

When filter 14 includes a plurality of filters 141, etc. (described later), display 15 outputs an amplitude, which has been calculated by each of the plurality of filters 141, etc. in association with its temporal position, with the amplitude being associated with the temporal position. In this case, it is assumed that when calculating an amplitude of a vibration component, each of the plurality of filters 141, etc. calculates the amplitude of the vibration component in association with the temporal position of the vibration component included in the vibration data.

Note that display 15 is an example of an outputter that outputs the amplitude calculated by filter 14. As an example different from display 15, the outputter may output the amplitude calculated by filter 14 to a different device via communication IF 11. Here, when outputting the amplitude, the outputter may output the amplitude, which has been calculated by filter 14 in association with its temporal position, with the amplitude being associated with the temporal position. In this case, the device that obtains the outputted amplitude may perform a process to control machining equipment 20 to suppress vibration having such an amplitude, or may display the amplitude on the display screen.

The processing by information processing device 10 will be described below in detail.

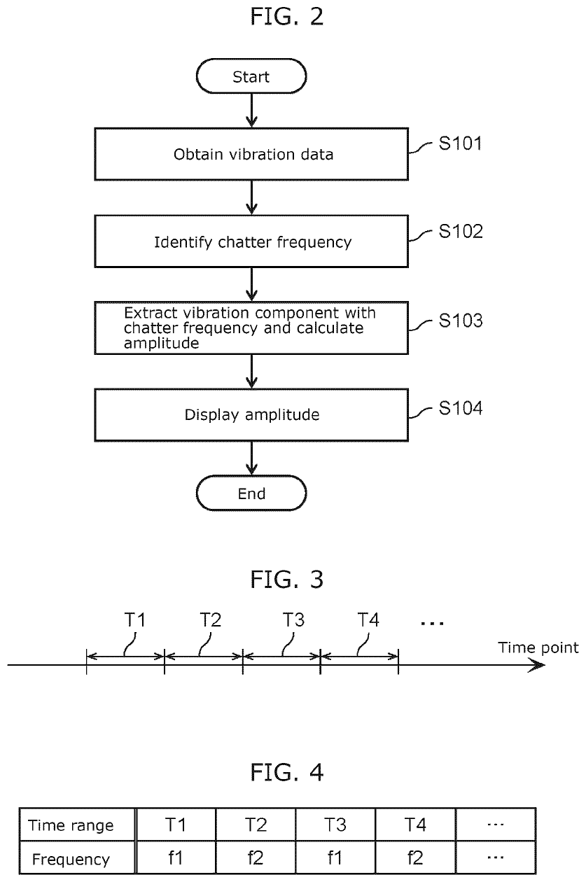

FIG. 2 is a first flow diagram showing the processing by information processing device 10 in the present embodiment.

In step S101, obtainer 12 obtains vibration data indicating vibration produced during machining performed by machining equipment 20.

In step S102, analyzer 13 analyzes the vibration data obtained by obtainer 12 in step S101 to identify one or more frequencies of chatter vibrations (i.e., corresponding to chatter frequencies) included in the vibration indicated in the vibration data.

In step S103, filter 14 extracts a vibration component that includes the one or more chatter frequencies and is included in the vibration indicated in the vibration data obtained by communication IF 11 in step S101, and calculates an amplitude of the extracted vibration component.

In step S104, display 15 displays the amplitude calculated in step S103. The amplitude displayed by display 15 is the amplitude of each of the one or more chatter vibrations included in the vibration data obtained by obtainer 12 in step S101, i.e., the vibration produced during the machining performed by machining equipment 20.

The series of processes shown in FIG. 2 allows information processing device 10 to achieve early detection of the specific vibration produced by machining equipment 20.

Information processing device 10 can detect (1) one chatter vibration, and (2) a plurality of chatter vibrations. Each of (1) and (2) described above will be described below.

(1) A configuration in which information processing device 10 detects one chatter vibration: In the configuration in which information processing device 10 detects one chatter vibration, analyzer 13 identifies one chatter frequency (step S102). Filter 14 also extracts a vibration component with the one chatter frequency identified by analyzer 13 and calculates an amplitude of the vibration component (step S103).

In this way, information processing device 10 is capable of early detection of one chatter vibration included in vibration produced by machining equipment 20.

(2) A configuration in which information processing device 10 detects a plurality of chatter vibrations: In the configuration in which information processing device 10 detects a plurality of chatter vibrations, analyzer 13 identifies a plurality of chatter frequencies (step S102). Thereafter, filter 14 may (2-1) detect the plurality of chatter vibrations in a time-division manner or (2-2) detect the plurality of chatter vibrations in parallel using a plurality of filters.

(2-1) A Case where a Plurality of Chatter Vibrations are Detected in a Time-Division Manner

In the configuration in which information processing device 10 detects a plurality of chatter vibrations in a time-division manner, after analyzer 13 identifies the plurality of chatter frequencies, filter 14 extracts vibration components in a time-division manner for the plurality of chatter frequencies identified by analyzer 13 and calculates an amplitude of each of the vibration components extracted in a time-division manner (step S103).

The processing by filter 14 in this case will be described in detail with reference to FIGS. 3 and 4.

FIG. 3 is an explanatory diagram showing time ranges in the processing by filter 14 in the present embodiment. FIG. 4 is an explanatory diagram showing mapping between the time ranges and frequencies in the processing by filter 14 in the present embodiment.

Each of time ranges T1, T2, T3, T4, . . . shown in FIG. 3 is a time unit for time-division processing performed by filter 14. Note that time ranges T1, etc. may be arranged with an appropriate time interval therebetween.

Filter 14 maps each of the plurality of chatter frequencies (also referred to as N chatter frequencies) identified by analyzer 13 to a time range among at least N time ranges. Filter 14 has mapping information indicating the above-described mapping, for example.

In the mapping performed by filter 14, each of the plurality of chatter frequencies identified by analyzer 13 is mapped to a time range among the at least N time ranges without overlap, i.e., a plurality of chatter frequencies are not mapped to a time range.

An example of the mapping information is a mapping table shown in FIG. 4.

The mapping table shown in FIG. 4 is stored in a memory device (a memory such as a Random Access Memory (RAM), or a storage such as a Hard Disk Drive (HDD) or a Solid State Drive (SSD)) included in information processing device 10.

FIG. 4 is the mapping table that maps two chatter frequencies f1 and f2 identified by analyzer 13 to four time ranges T1 to T4. This corresponds to a case where the N chatter frequencies are two chatter frequencies (i.e., N=2) and the at least N time ranges are four time ranges.

In the mapping table shown in FIG. 4, chatter frequency f1 is mapped to time ranges T1 and T3, and chatter frequency f2 is mapped to time ranges T2 and T4.

Note that the format of the mapping information is not limited to the mapping table shown in FIG. 4, but may be information that maps a plurality of frequencies to a time range among the at least N time ranges (such as a software algorithm).

In each of four time ranges T1 to T4, filter 14 extracts a vibration component with the chatter frequency mapped to the time range and calculates an amplitude of the extracted vibration component. The mapping between the time ranges and the chatter frequencies can be obtained, for example, by referring to the mapping table shown in FIG. 4.

Specifically, filter 14 calculates the amplitude of the vibration component with chatter frequency f1 in time range T1, the amplitude of the vibration component with chatter frequency f2 in time range T2, the amplitude of the vibration component with chatter frequency f1 in time range T3, and the amplitude of the vibration component with chatter frequency f2 in time range T4.

(2-2) A Configuration in which a Plurality of Chatter Vibrations are Detected in Parallel by a Plurality of Filters

In the configuration in which information processing device 10 detects a plurality of chatter vibrations in parallel by a plurality of filters, after analyzer 13 identifies a plurality of chatter frequencies, filter 14 extracts vibration components using the plurality of filters and calculates an amplitude of each of the extracted vibration components (step S103).

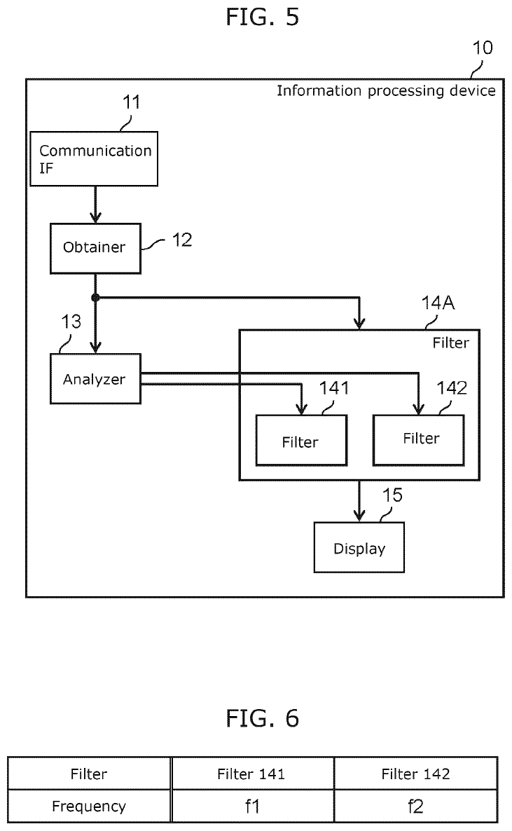

The configuration of information processing device 10 in this case will be described in detail with reference to FIGS. 5 and 6.

FIG. 5 is a schematic diagram illustrating an example of the configuration of information processing device 10 in the present embodiment. FIG. 6 is an explanatory diagram showing mapping between filters and frequencies in the processing by the filters in the present embodiment.

Information processing device 10 shown in FIG. 5 includes communication IF 11, obtainer 12, analyzer 13, filter 14A, and display 15. Among the components of information processing device 10 shown in FIG. 5, filter 14A differs from filter 14 in FIG. 1. Parts related to filter 14A will be described below.

Filter 14A includes filters 141 and 142 (also referred to as filters 141, etc.). Note that the number of filters 141, etc. included in filter 14A is greater than or equal to the number of chatter frequencies to be identified by analyzer 13. The number of filters 141, etc. included in filter 14A is two, for example, when the number of chatter frequencies to be identified by analyzer 13 is two.

Filter 14A maps each of the plurality of frequencies identified by analyzer 13 to one filter among the plurality of filters 141, etc. Filter 14A has, for example, mapping information indicating the above-described mapping.

In the mapping performed by filter 14A, each of the plurality of chatter frequencies identified by analyzer 13 is mapped to one filter among filters 141, etc. without overlap, i.e., a plurality of chatter frequencies are not mapped to one filter.

An example of the mapping information is a mapping table shown in FIG. 6.

The mapping table shown in FIG. 6 is stored in the memory device included in information processing device 10.

FIG. 6 is a mapping table that maps two chatter frequencies f1 and f2 identified by analyzer 13 to two filters 141 and 142.

In the mapping table shown in FIG. 6, chatter frequency f1 is mapped to filter 141, and chatter frequency f1 is mapped to filter 142.

Note that the format of the mapping information is not limited to the format of the mapping table shown in FIG. 6, as with FIG. 4.

In each of two filters 141, etc., filter 14A extracts a vibration component with the chatter frequency mapped to the filter, and calculates an amplitude of the extracted vibration component. The mapping between filters 141, etc. and the chatter frequencies can be obtained, for example, by referring to the mapping table shown in FIG. 6.

Specifically, filter 141 obtains chatter frequency f1 mapped to filter 141 in the mapping table shown in FIG. 6 among the plurality of chatter frequencies identified by analyzer 13. Thereafter, filter 141 extracts a vibration component with chatter frequency f1, which is included in vibration indicated in vibration data obtained by obtainer 12, and calculates an amplitude of the extracted vibration component.

Filter 142 obtains chatter frequency f2 mapped to filter 142 in the mapping table shown in FIG. 6 among the plurality of chatter frequencies identified by analyzer 13. Thereafter, filter 142 extracts a vibration component with chatter frequency f2, which is included in the vibration indicated in the vibration data obtained by obtainer 12, and calculates an amplitude of the extracted vibration component.

An example of data for output, which is generated by filter 14A, will be described next. Although the description will be made here using filter 14A, the same applies to the case where filter 14 detects a plurality of chatter frequencies in a time-division manner ((2-1) described above).

When analyzer 13 identifies one or more chatter frequencies that vary from time point to time point and filter 14A calculates an amplitude of a vibration component with each of the one or more chatter frequencies at each time point, filter 14A generates data (also referred to as data for output) by compiling such a chatter frequency and such an amplitude at each time point, and provides the data to display 15 so that the data can be displayed on display 15.

When analyzer 13 identifies a plurality of chatter frequencies at each time point, in particular, filter 14A calculates amplitudes of vibration components with the plurality of chatter frequencies. In such a case, filter 14A can generate data (also referred to as data for output) by compiling the amplitudes of the vibration components with the plurality of chatter frequencies, which have been calculated in association with their temporal position, so as to have a common time axis, and provide the data to display 15.

When filter 14 detects a plurality of chatter frequencies in a time-division manner ((2-1) described above), a chatter frequency corresponding to a time range may not have been identified by analyzer 13. In such a case, filter 14 may use, as the chatter frequency for the time range for which the chatter frequency has not been identified, the same chatter frequency as a chatter frequency before the time range or after the time range.

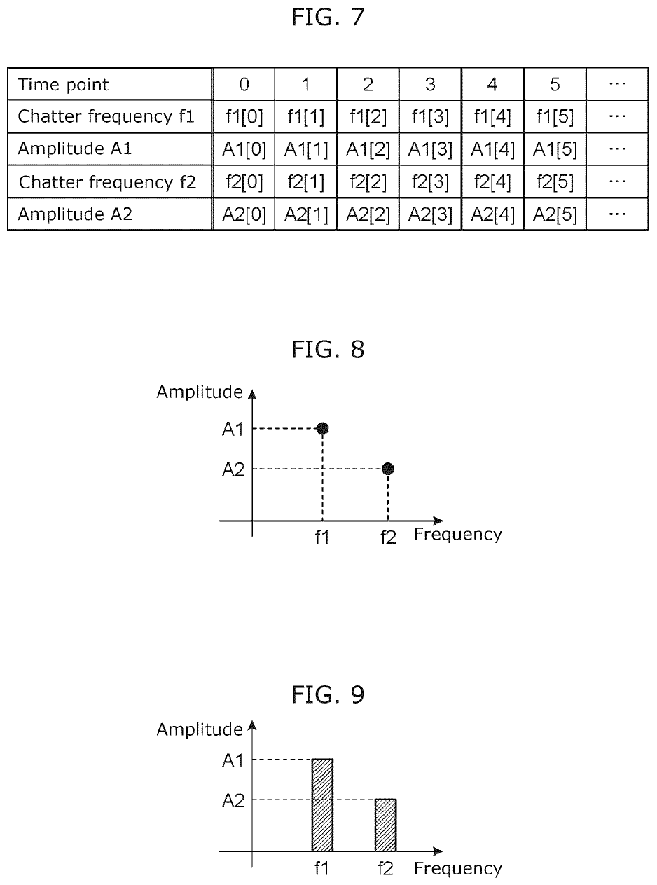

FIG. 7 is an explanatory diagram showing data for output, which is generated by filter 14 in the present embodiment.

The data for output, which is shown in FIG. 7, includes a time point, chatter frequency f1, amplitude A1, chatter frequency f2, and amplitude A2.

Such a time point in FIG. 7 has a time axis common to chatter frequency f1, amplitude A1, chatter frequency f2, and amplitude A2.

Chatter frequency f1 represents a chatter frequency among the plurality of chatter frequencies identified by analyzer 13 at each time point. For example, f1[1] is a chatter frequency among a plurality of chatter frequencies at time point 1, which have been identified by analyzer 13.

Amplitude A1 represents an amplitude of chatter frequency f1 at each time point. For example, A1[1] is an amplitude of chatter frequency f1 at time point 1.

Chatter frequency f2 represents a chatter frequency different from f1 among the plurality of chatter frequencies identified by analyzer 13 at each time point. For example, f2[1] is a chatter frequency different from f1[1] among the plurality of chatter frequencies at time point 1, which have been identified by analyzer 13.

Amplitude A2 represents an amplitude of chatter frequency f2 at each time point. For example, A2[1] is an amplitude of chatter frequency f2 at time point 1.

As a result of filter 14 outputting the data for output, which is shown in FIG. 7, display 15 can display the amplitudes of the vibration components with the plurality of chatter frequencies, which have been calculated in association with their temporal positions, thus allowing a user to recognize such amplitudes. Alternatively, when information processing device 10 includes an outputter instead of display 15, the data for output can be outputted to a different device via communication IF 11 so that the different device can perform a process to control machining equipment 20 to suppress a specific vibration, for example.

Specific examples of the display performed by display 15 will be described next. Although a case where two chatter frequencies are identified by analyzer 13 (i.e., a case corresponding to (2-1) and (2-2) described above) is described here, the same description applies to any number of chatter frequencies that is greater than or equal to one.

FIG. 8 is an explanatory diagram showing a first example of an image outputted by information processing device 10 in the present embodiment.

The image shown in FIG. 8 is a graphical image showing, as a scatter diagram, chatter frequencies and an amplitude of a vibration component for each of the chatter frequencies.

In the graphical image shown in FIG. 8, the horizontal axis represents the chatter frequencies, and the vertical axis represents the amplitude of the vibration component for each of the chatter frequencies. For example, f1 and f2 are shown as the chatter frequencies, and the amplitudes of the vibration components with chatter frequencies f1 and f2 are shown as A1 and A2, respectively.

As a result of display 15 displaying the graphical image shown in FIG. 8, a user who views the above-described graphical image can grasp the chatter frequencies produced by machining equipment 20 and the amplitude of the vibration component for each of the chatter frequencies.

FIG. 9 is an explanatory diagram showing a second example of the image outputted by information processing device 10 in the present embodiment.

The image shown in FIG. 9 is a graphical image showing, as a column graph, chatter frequencies and a chatter amplitude for each of the chatter frequencies.

In the graphical image shown in FIG. 9, the horizontal axis represents the chatter frequencies, and the vertical axis represents the amplitude of the vibration component for each of the chatter frequencies. For example, f1 and f2 are shown as the chatter frequencies, and the amplitudes of the vibration components with chatter frequencies f1 and f2 are shown as A1 and A2, respectively.

As a result of display 15 displaying the graphical image shown in FIG. 9, a user who views the above-described graphical image can grasp the chatter frequencies produced by machining equipment 20 and the amplitude of the vibration component for each of the chatter frequencies.

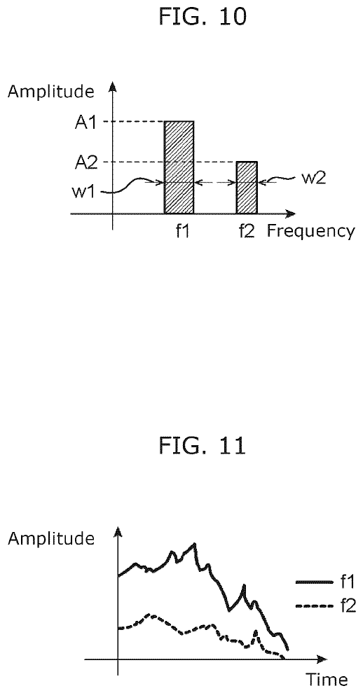

FIG. 10 is an explanatory diagram showing a third example of the image outputted by information processing device 10 in the present embodiment.

The image shown in FIG. 10 is a graphical image showing, as a column graph, chatter frequencies, an amplitude of a vibration component for each of the chatter frequencies, and passband widths of bandpass filters.

In the graphical image shown in FIG. 10, the horizontal axis represents the chatter frequencies, and the vertical axis represents the amplitude of the vibration component for each of the chatter frequencies. The passband widths of the bandpass filters in filter 14A (more specifically, filters 141, etc.) are represented as widths of the column graph. For example, f1 and f2 are shown as the chatter frequencies, the amplitudes of the vibration components with chatter frequencies f1 and f2 are shown as A1 and A2, respectively, and the passband widths of the bandpass filters in filters 141 and 142 are shown as w1 and w2, respectively.

As a result of display 15 displaying the graphical image shown in FIG. 10, a user who views the above-described graphical image can grasp the chatter frequencies produced by machining equipment 20 and the amplitude of the vibration component for each of the chatter frequencies, and can further grasp the passband widths of the bandpass filters used by filter 14A to calculate the amplitudes of the chatter vibrations.

FIG. 11 is an explanatory diagram showing a fourth example of the image outputted by information processing device 10 in the present embodiment.

The image shown in FIG. 11 is a graphical image showing temporal variations of chatter frequencies.

In the graphical image shown in FIG. 11, the horizontal axis represents time, and the vertical axis represents an amplitude of a vibration component for each of the chatter frequencies. For example, the amplitudes of the chatter vibrations for chatter frequencies f1 and f2 are shown with a solid line and a broken line, respectively.

As a result of display 15 displaying the graphical image shown in FIG. 11, a user who views the above-described graphical image can grasp the chatter frequencies produced by machining equipment 20 and the amplitude of the vibration component for each of the chatter frequencies on a time-series basis.

As described above, information processing device 10 in the present embodiment is capable of early detection of a specific vibration produced by machining equipment 20.

### (Variation of Embodiment)

With regard to the information processing device, etc., capable of early detection of a specific vibration produced by machining equipment, the present variation describes an example that differs from the above-described embodiment.

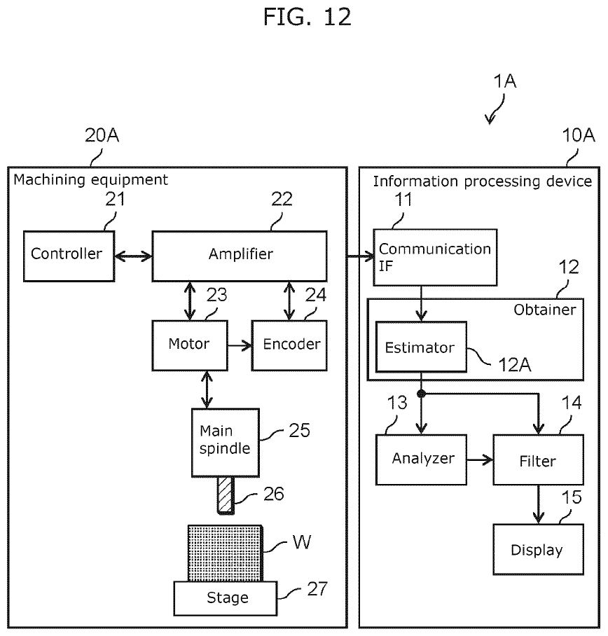

FIG. 12 is a schematic diagram illustrating configurations of information processing device 10A and system 1A in the present variation.

As shown in FIG. 12, system 1A includes information processing device 10A and machining equipment 20A. System 1A includes no sensor device 30 that is included in system 1 of the above-described embodiment.

Machining equipment 20A is a device that performs machining on workpiece W, as with machining equipment 20 in the above-described embodiment.

Machining equipment 20A has the functions provided by machining equipment 20, and further has a function to output a control value related to the control of machining equipment 20. Specifically, machining equipment 20A transmits, to information processing device 10A via a communication IF (not shown), time-series data of control values related to the control of machining equipment 20A. Such a control value related to the control of machining equipment 20A may include, for example, information indicating a controlled position, controlled rotational speed, or controlled torque of main spindle 25, or information indicating a position, rotational speed, or torque of main spindle 25. The control value related to the control of machining equipment 20A may also include information indicating a position, speed, or acceleration of stage 27. The transmitting of the control value to information processing device 10A by amplifier 22 corresponds to outputting of the control value.

As with information processing device 10 in the above-described embodiment, information processing device 10A includes communication IF 11, obtainer 12, analyzer 13, filter 14, and display 15. Part or all of the functions of obtainer 12, analyzer 13, filter 14, and display 15 are implemented as a result of a processor (e.g., a CPU) (not shown) included in information processing device 10A executing a predetermined program using a memory (not shown). Information processing device 10A is an information processing device capable of early detection of a specific vibration produced by machining equipment 20A.

Obtainer 12 included in information processing device 10A includes estimator 12A.

Estimator 12A obtains the control value outputted by machining equipment 20A and uses the obtained control value to estimate machining force exerted on workpiece W by machining equipment 20. The estimation of the machining force using the control value can be done by estimation using a disturbance observer (NPL 2). The machining force is force exerted on workpiece W when machining equipment 20A machines workpiece W (e.g., cutting force in cutting machining).

Obtainer 12 obtains, as vibration data, estimation data of the machining force estimated by estimator 12A. Obtainer 12 provides the obtained vibration data to analyzer 13.

Analyzer 13, filter 14, and display 15 are the same as the components with the same names in the above-described embodiment.

When machining equipment 20A is producing a chatter vibration, a component of the chatter vibration may be included in a control value outputted by machining equipment 20A. This is because the control by amplifier 22 is performed based on feedback provided to amplifier 22 from motor 23 (specifically, such as the position or rotational speed of motor 23).

In such a case, the control value outputted by machining equipment 20A may include the component of the chatter vibration being produced by machining equipment 20A. Therefore, the use of the control value outputted by machining equipment 20A as vibration data enables the early detection of the specific vibration produced by machining equipment 20A as with the above-described embodiment.

In the embodiment and the variation described above, each component may be configured as dedicated hardware or may be implemented by executing a software program suitable for the component. Each component may be implemented by a program executer, such as a CPU or a processor, reading and executing a software program recorded on a recording medium, such as a hard disk or a semiconductor memory. Here, the software that implements the information processing method, etc. according to the embodiment and the variation described above is a program as follows.

Specifically, the program is a program for causing a computer to execute an information processing method including: obtaining vibration data indicating vibration produced during machining performed by machining equipment; analyzing the vibration data obtained to identify one or more specific frequencies that are one or more frequencies of specific vibrations included in the vibration indicated in the vibration data; extracting a vibration component that includes the one or more specific frequencies and is included in the vibration indicated in the vibration data obtained, and calculating an amplitude of the vibration component extracted; and outputting the amplitude calculated.

Although the information processing device, etc. according to one or more aspects have been described above based on the embodiment, the present invention is not limited to this embodiment. Forms obtained by making various modifications to the present embodiment that can be conceived by those skilled in the art, as well as forms obtained by combining structural components in different embodiments, without materially departing from the spirit of the present invention, may be included in the scope of the one or more aspects.

### INDUSTRIAL APPLICABILITY

The invention according to the present disclosure can be applied, for example, to a diagnostic device, which is an information processing device that diagnoses the condition of machining performed by machining equipment, a machining phenomenon, machining processing, or the like.

### REFERENCE SIGNS LIST

1, 1A system
10, 10A information processing device
11 communication IF
12 obtainer
12A estimator
13 analyzer
14, 14A, 141, 142 filter
15 display
20, 20A machining equipment
21 controller
22 amplifier
23 motor
24 encoder
25 main spindle
26 tool
27 stage
30 sensor device
31 sensor
32 converter
T1, T2, T3, T4 time range
W workpiece

1. An information processing device comprising:
an obtainer that obtains vibration data indicating vibration produced during machining performed by machining equipment;
an analyzer that analyzes the vibration data obtained by the obtainer to identify one or more specific frequencies that are one or more frequencies of specific vibrations included in the vibration indicated in the vibration data;
a filter that extracts a vibration component that includes the one or more specific frequencies and is included in the vibration indicated in the vibration data obtained by the obtainer, and calculates an amplitude of the vibration component extracted; and
an outputter that outputs the amplitude calculated by the filter.

2. The information processing device according to claim 1,
wherein the analyzer identifies one specific frequency as the one or more specific frequencies, and
the filter extracts a vibration component that includes the one specific frequency and is included in the vibration, and calculates an amplitude of the vibration component extracted.

3. The information processing device according to claim 1,
wherein the analyzer identifies N specific frequencies as the one or more specific frequencies, N being an integer that is greater than or equal to two, and
the filter:
maps each of the N specific frequencies to a time range among N time ranges; and
for each of the N time ranges, extracts a vibration component including the specific frequency, among the N specific frequencies, that is mapped to the time range, and calculates an amplitude of the vibration component extracted.

4. The information processing device according to claim 1,
wherein when calculating the amplitude of the vibration component, the filter calculates the amplitude of the vibration component in association with a temporal position of the vibration component included in the vibration data, and
when outputting the amplitude, the outputter outputs the amplitude in association with the temporal position, the amplitude being calculated by the filter in association with the temporal position.

5. The information processing device according to claim 1,
wherein the analyzer identifies N specific frequencies as the one or more specific frequencies, N being an integer that is greater than or equal to two,
the filter:
includes N filters; and
maps each of the N specific frequencies to a filter among the N filters, and
each of the N filters extracts a vibration component including the specific frequency, among the N specific frequencies, that is mapped to the filter, and calculates an amplitude of the vibration component extracted.

6. The information processing device according to claim 5,
wherein when calculating the amplitude of the vibration component, each of the N filters calculates the amplitude of the vibration component in association with a temporal position of the vibration component included in the vibration data, and
when outputting the amplitude, the outputter outputs the amplitude in association with the temporal position, the amplitude being calculated by each of the N filters in association with the temporal position.

7. The information processing device according to claim 1,
wherein the obtainer obtains the vibration data from a vibration sensor that detects vibration produced during machining performed by the machining equipment.

8. The information processing device according to claim 1,
wherein the obtainer further includes an estimator that obtains a control value outputted by the machining equipment and uses the control value obtained to estimate machining force exerted on a workpiece by the machining equipment, and
the obtainer obtains, as the vibration data, estimation data of the machining force estimated by the estimator.

9. The information processing device according to claim 1,
wherein the analyzer:
includes a Kalman filter; and
identifies the one or more specific frequencies by estimation using the Kalman filter, and
the filter:
includes a bandpass filter; and
extracts a vibration component that includes the one or more specific frequencies using the bandpass filter that uses each of the one or more specific frequencies as a pass frequency.

10. An information processing method comprising:
obtaining vibration data indicating vibration produced during machining performed by machining equipment;
analyzing the vibration data obtained to identify one or more specific frequencies that are one or more frequencies of specific vibrations included in the vibration indicated in the vibration data;
extracting a vibration component that includes the one or more specific frequencies and is included in the vibration indicated in the vibration data obtained, and calculating an amplitude of the vibration component extracted; and
outputting the amplitude calculated.

11. A non-transitory computer-readable recording medium having recorded thereon a program for causing a computer to execute the information processing method according to claim 10.
